(19) United States
(12) Patent Application Publication
(10) Pub. No.: US 2004/0068920 A1
(43) Pub. Date: Apr. 15, 2004

(54) Stabilized fragrance candle wax

(76) Inventors: Thomas P. Steele, Milford, CT (US); Jerry M. Eng, Shanghai (CN)

Correspondence Address: Cytec Industries Inc., Patent Law Dept., 1937 W. Main St., P.O. Box 60, Stamford, CT, 06904-0060, US

(21) Appl. No.: 10/650,587

(22) Filed: Aug. 28, 2003

Related U.S. Application Data
(60) Provisional application No. 60/407,095, filed on Aug. 30, 2002.

(51) Int. Cl. C10L 7/00; C11C 5/00; C10L 5/00

(52) U.S. Cl. 44/275

(57) ABSTRACT

This invention relates to a stabilized fragrance candle composition comprising wax, fragrance and a stabilizing composition comprising a UV absorber and a hindered hydroxybenzoate.

This application claims the benefit under 35 U.S.C. § 119(e) of U.S. Provisional Application Serial No. 60/407,095, filed Aug. 30, 2002.

### FIELD OF THE INVENTION

This invention relates to an improved stabilized candle wax containing fragrances. More specifically, this invention relates to a candle composition containing UV absorbers and a hindered hydroxybenzoate.

### BACKGROUND OF THE INVENTION

Fragrance candles have become very popular with the consuming public. The incorporation of fragrance oil in candle wax is difficult to achieve in quantity thus making it problematic to ensure the release of a suitable level of fragrance into the atmosphere for the end use customer. The incorporated fragrance tends to migrate and volatilize from the wax body prematurely. In addition, over time, the fragrance itself may become unstable causing a shift in scent. Thus, there is a need to stabilize fragrances in candles to reduce the shift in scent and the amount of fragrance that is released prematurely.

### SUMMARY OF THE INVENTION

This invention relates to a stabilized fragrance candle composition comprising wax, fragrance and a stabilizing composition comprising a UV absorber and a hindered hydroxybenzoate. The inventors have discovered that the utilization of the stabilizing composition comprising the UV absorber and hindered hydroxybenzoate reduces the amount of fragrance prematurely released from the candle.

### DETAILED DESCRIPTION OF THE INVENTION

This invention relates to a stabilized fragrance candle composition comprising wax, fragrance and a stabilizing composition comprising a UV absorber and a hindered hydroxybenzoate. The inventors have discovered that the utilization of the stabilizing composition comprising the UV absorber and hindered hydroxybenzoate reduces the amount of fragrance prematurely released from the candle.

Any suitable wax may be used in this invention. Among the suitable are natural waxes like insect and animal waxes such as beeswax, lanolin, shellac wax, chinese insect wax, and spermaceti; vegetable waxes such as camauba, candelila, japan wax, ouricury wax, rice-bran wax, jojoba wax, castor wax, bayberry wax, sugar cane wax, soybean wax palm wax and maize wax; mineral waxes such as montan wax, peat wax, petroleum waxes including petrolatum, paraffin wax, semimicrocrystalline wax, and microcrystalline wax, ozokerite and ceresin waxes; and the synthetic waxes such as polyethylene wax, Fischer-Tropsch wax, chlorinated naphthalene wax, chemically modified wax, substituted amide wax, ester waxes, hydrogenated vegetable fats and derivatives, alpha olefins and polymerized alpha olefin wax.

The fragrance to be stabilized in the candle composition may be any suitable fragrance used in the candle art. Examples of such fragrances include limonene, α-terpinene, α-pinene, camphene, undecanol, 4-isopropylcyclohexanol, geraniol, linalool, citronellol, farnesol, menthol, 3-trans-isocamphylcyclohexanol, benzyl alcohol, 2-phenylethyl alcohol, 3-phenylpropanol, 3-methyl-5-phenylpentanol, cinnamic alcohol, isobomeol, thymol, eugenol, isoeugenol, anise alcohol, methyl salicylate, and the like.

Other suitable fragrance compounds include aldehydes and ketones such as hexanal, decanal, 2-methyldecanal, trans-2-hexenal, acetoin, diacetyl, geranial, citronellal, methoxydihydro-citronellal, menthone, carvone, camphor, fenchone, ionone, irone, damascone, cedryl methyl ketone, muscone, civetone, 2,4-dimethyl-3-cyclohexene carboxaldehyde, 2-heptylcyclopentanone, cis-jasmone, dihydrojasmone, cyclopentadecanone, benzaldehyde, phenylacetaldehyde, dihydrocinnamaldehyde, cinnamaldehyde, α-amylcinnamaldehyde, acetophenone, benzylacetone, benzophenone, piperonal, and the like.

Still other suitable fragrance compounds include esters such as trans-2-hexenyl acetate, allyl 3-cyclohexylpropionate, methyl cinnamate, benzyl cinnamate, phenylethyl cinnamate, and the like.

Yet other suitable compounds include crystalline fragrance materials with a high vapor pressure, such as vanillin, ethyl vanillin, coumarin, tonalid, calone, heliotropene, musk xylol, cedrol, musk ketone, benzophenone, raspberry ketone, methyl naphthyl ketone beta, phenyl ethyl salicylate, veltol, maltol, maple lactone, proeugenol acetate, evemyl, and the like.

Any suitable UV absorber may be used as the UV absorbers of this invention. Examples of such UV absorbers are: 2-(2′-hydroxyphenyl)benzotriazoles; 2-hydroxybenzophenones; 2-(2-hydroxyphenyl)-1,3,5-triazines; phenyl salicylates; benzoxazinones; cinnamates and oxanilides. The preferred UV absorbers are 2-(2′-hydroxyphenyl)benzotriazoles and 2-hydroxybenzophenones.

Suitable examples of 2-(2′-hydroxyphenyl)benzotriazoles that may be used in the present invention are: 2-(2′-hydroxy-5′-methylphenyl)-benzotriazole; 2-(3′,5′-di-tert-butyl-2′-hydroxyphenyl)benzotriazole; 2-(5′-tert-butyl-2′-hydroxyphenyl)benzotriazole; 2-(2′-hydroxy-5′-(1,1,3,3-tetramethylbutyl)phenyl)benzotriazole; 2-(3′,5′-di-tert-butyl-2′-hydroxyphenyl)-5-cholorobenzotriazole; 2-(3′-tert-butyl-2′-hydroxy-5′-methylphenyl)-5-chloro-benzotriazole; 2-(3′-sec-butyl-5′-tert-butyl-2′-hydroxyphenyl)-benzotriazole; 2-(2′-hydroxy-4′-octoxyphenyl)benzotriazole; 2-(3′,5′-di-tert-amyl-2′-hydroxyphenyl)benzotriazole; 2-(3′,5′-bis(α,α-dimethylbenzyl)-2′-hydroxyphenyl)-benzotriazole; a mixture of 2-(3′-tert-butyl-2′-hydroxy-5′-(2-octyloxycarbonylethly)phenyl)-5-chloro-benzotriazole; 2-(3′-tert-butyl-5′-[2-(2-ethylhexyloxy)-carbonylethyl]-2′-hydroxyphenyl)-5-chloro-benzotriazole; 2-(3′-tert-butyl-2′-hydroxy-5′-(2-methoxycarbonylethyl)phenyl)-5-chloro-benzotriazole; 2-(3′-tert-butyl-2′-hydroxy-5′-(2-methoxycarbonylethyl)phenyl)benzotriazole; 2-(3′-tert-butyl-2′-hydroxy-5′-(2-octyloxycarbonylethyl)phenyl)benzotriazole; 2-(3′-tert-butyl-5′-[2-(2-ethylhexyloxy)carbonylethyl]-2′-hydroxyphenyl)benzotriazole; 2-(3′-dodecyl-2′-hydroxy-5′-methylphenyl)benzotriazole and 2-(3′-tert-butyl-2′-hydroxy-5′-(2-isooctyloxycarbonylethyl)phenylbenzotriazole; 2,2-methylenebis[4-(1,1,3,3-tetramethylbutyl)-6-benzotriazol-2-ylphenol]; the transesterification product of 2-[3′-tert-butyl-5′-(2-methoxycarbonylethyl)-2′-hydroxyphenyl]benzotriazole with polyethylene glycol 300; and [R—CH₂CH—COO(CH₂)₃]₂ B where R=3′-tert-butyl-4′-hydroxy-5′-2H-benzotriazol-2-ylphenyl and mixture thereof.

Suitable examples of 2-hydroxybenzophenones that may be used in the present invention are 2-hydroxy-4-hydroxy-benzophenone; 2-hydroxy-4-methoxy-benzophenone; 2-hydroxy-4-octoxy-benzophenone; 2-hydroxy-4-decyloxy-benzophenone; 2-hydroxy-4dodecylox-benzophenone; 2-hydroxy-4-benzyloxy-benzophenone; 2′,4,4′-trihydroxy-benzophenones; 2-hydroxy-4,4′-dimethoxy-benzophenone; 2,2′-dihydroxy-4-methoxybenzophenone; 2-hydroxy-4-n-octoxy-benzophenone and mixtures thereof.

The hindered hydroxybenzoate compound of the present invention may be any suitable hindered hydroxybenzoate compound such as those having the formula V:

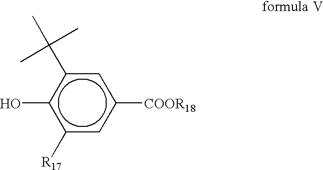

wherein R₁₇ is a C₁-C₈ alkyl and R₁₈ is a C₁-C₂₄ alkyl, or substituted or unsubstituted C₁-C₂₄ aryl. Preferably, R₁₇ is t-butyl and R₁₈ is a C₁₀-C₂₀ alkyl.

Examples of suitable hindered hydroxybenzoate compounds include: 2,4-di-tert-butylphenyl-3,5-di-tert-butyl-4-hydroxybenzoate; hexadecyl-3,5-di-tert-butyl-4-hydroxybenzoate; octadecyl-3,5-di-tert-butyl-4-hydroxybenzoate; octyl-3,5-di-tert-butyl-4-hydroxybenzoate; tetradecyl-3,5-di-tert-butyl-4-hydroxybenzoate; behenylyl-3,5-di-tert-butyl-4-hydroxybenzoate; 2-methyl-4,6-di-tert-butylphenyl-3,5-di-tert-butyl-4-hydroxybenzoate and butyl 3-[3-t-butyl-4-(3,5-di-t-butyl-4-hydroxybenzoyloxy)phenyl]propionate.

In addition to the above UV absorbers and hindered hydroxybenzoate compounds, pigments may be added to the fragrance candle compositions. The term “pigment” means to refer to both pigments and dyes, which impart a color, including white, black and/or shades of gray, to the composition.

One type of suitable pigment that may be used in the present invention is organic pigments, including but not limited to azo, azomethine, methine, anthraquinone, phthalocyanine, perinone, perylene, diketopyrrolopyrrole, thioindigo, iminoisoindoline, dioxazine, iminoisoindolinone, quinacridone, flavanthrone, indanthrone, anthrapyrimidine and quinophthalone pigments or mixtures thereof.

Notable pigments that may be used are those described in the Color Index, including but not limited to C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 95, C.I. Pigment Yellow 109, C.I. Pigment Yellow 110, C.I. Pigment Yellow 147, C.I. Pigment Yellow 191.1, C.I. Pigment Yellow 74, C.I. Pigment Yellow 83, C.I. Pigment Yellow 13, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 29, C.I. Pigment Violet 37, C.I. Pigment Violet 19, C.I. Pigment Green 7, and C.I. Pigment Green 36, or mixtures thereof.

Suitable inorganic pigments useful in the present invention, include, but are not limited to carbon black, metal oxides such as iron oxide, mixed metal oxides, antimony yellow, lead chromate, lead chromate sulfate, lead molybdate, ultramarine blue, cobalt blue, manganese blue, chrome oxide green, hydrated chrome oxide green, cobalt green, metal sulfides, cadmium sulfoselenides, zinc ferrite, and bismuth vanadate, titanium dioxide and mixtures thereof.

The amount of the UV absorber in the candle composition is about 0.01 to about 1 wt %, preferably about 0.1 to about 0.5 wt %, and the amount of the hindered hydroxybenzoate in the candle composition is about 0.01 to about 1 wt %, preferably about 0.1 to about 0.5 wt %, based on the total weight of the candle composition.

In one embodiment of this invention, the candle composition comprises wax, fragrance, and a stabilizing composition comprising a 2-(2′-hydroxyphenyl)benzotriazole, a 2-hydroxybenzophenone and a hindered hydroxybenzoate. In that case, the amount of the 2-(2′-hydroxyphenyl)benzotriazole in the candle composition is about 0.01 to about 1 wt %, preferably about 0.1 to about 0.5 wt %, the amount of the 2-hydroxybenzophenone in the candle composition is about 0.01 to about 1 wt %, preferably about 0.1 to about 0.5 wt %, and the amount of the hindered hydroxybenzoate in the candle composition is about 0.01 to about 1 wt %, preferably about 0.1 to about 0.5 wt %, based on the total weight of the candle composition.

It should be noted that candles may contain a number of various components. Such candle components may be, for example: paraffin wax, natural oils, polyamide plus fatty acid/ester, fatty acids such as stearin, opacifiers, beeswax, glycerides plus oxidized wax, alcohols, ethylene oligomers, mold release agents, fragrances, insect repellants or insecticides, hardeners, crystal modifiers, clarifiers, guttering reducers, pigments, f.p. control agents, stretchability improvers, gelling agents, extrusion aids, vortex reducers or antioxidants such as Cyanox® 1790 (1,3,5-tris(4-tert-butyl-3-hydroxy-2,6-dimethyl benzyl)-1,3,5-triazine-2,4,6-(1H,3H,5H)-trione); tris(2,4-di-tert-butylphenyl) phosphate or mixtures of such antioxidants (e.g., Cyanox® 2777 and Cyanox® 2888 from Cytec Industries Inc.).

The present invention will now be illustrated by the following examples. The examples are not intended to limit the scope of the present invention. In conjunction with the general and detailed descriptions above, the examples provide further understanding of the present invention.

### EXAMPLES

The following are prophetic examples.

### Example 1

### Testing Retention of Candle Wax Fragrance

The procedure for testing the retention of fragrance is as follows. To a melting pot is placed 600 grams of 139° F. molding/taper candle wax. The melting pot is placed in simmering water in a steamer pot. The handle of the melting pot will hang outside of the steamer pot. The wax is melted at approximately 190° F. To the wax is added approximately 1% by weight (6 grams) of Vybar® 103, from Baker Petrolite Corporation (a hardener/binder). The Vybar is mixed into the wax with a magnetic stirrer until the mixture is homogenous.

The wax mixture is split into 300 gram samples and is placed into two melting pots. Into one melting pot is placed 0.3% (0.9 grams) of the control stabilizing additive Cyasorb® UV-594, which is a 1:1 by weight mixture of Cyasorb® UV-531 (2-hydroxy-4-n-octoxybenzophenone) and Cyasorb® UV 5411 (2-(2′-hydroxy-5′-octylphenyl)benzotriazole) from Cytec Industries Inc. Into the second pot is placed a stabilizing composition of the present invention, which is a mixture of 0.2% (0.6 grams) of Cyasorb UV-594 and 0.1% (0.3 grams) of Cyasorb® UV-2908 (hexadecyl-3,5-di-tert-butyl-4-hydroxybenzoate). Both mixtures are mixed with a magnetic stirrer. The wax mixtures are allowed to sit for about 20 to 30 minutes to reduce flaws caused by air bubbles. Then approximately 0.05% (0.15 grams) liquid brown dye and 1% (3 grams) of chocolate fragrance are added to both molten wax mixtures and mixed with a magnetic stirrer. The samples are then left to sit for 4 hours at approximately 190° F.

A portion (approximately 10 grams) of each sample is poured off and left to cool. Once cooled, the samples are then placed in 16 ounce jars with the lids securely fastened. The samples are left for 2 days at room temperature.

The samples are then arranged so that there are sets of three jars. Two jars will be the same and the 3^{rd} will be different. Thus, there may be two samples containing the mixture of UV-2908 and UV-594 and the third only contains UV-594, or two jars may contain only UV-594 and the third may contain the mixture of UV-2908 and UV-594.

The sets of three jars are then given to a panel of 9 individual testers. Each individual tester will smell the three samples in their set and attempt to identify the different jar and then describe how the fragrance differs between the jars (e.g., either a stronger or weaker fragrance or shift in final scent, i.e., more acrid, change in bouquet, etc.) If a majority of the testers indicate a difference in fragrance, it means that the stabilizers will have a significant affect on the retention of the fragrance.

In the samples described above, a majority of the testers will report that the jars containing the mixture of UV-594 and UV-2908 will have a stronger fragrance than the UV-594 alone.

### Examples 2 to 5

### Candle Wax Fragrance Testing

The samples for the following Examples are prepared and tested according to the procedure in Example 1, except as noted in Table 1.

TABLE 1
Testing of Candle Wax Fragrance

| | Stabilizer | | |
|---|---|---|---|
| Example | Components^{#} | Wax Temp.* | Results |
| 2 | UV-594 and | 230° F. | Greater than 50% testers |
| | UV-2908 | | report stronger fragrance |
| | | | than 2C |
| 2C | UV-594 | 230° F. | |
| 3 | UV-594 and | 300° F. | Greater than 50% testers |
| | UV-2908 | | report stronger fragrance |
| | | | than 3C |
| 3C | UV-594 | 300° F. | |
| 4 | UV-541 and | 190° F. | Greater than 50% testers |
| | UV-2908 | | report stronger fragrance |
| | | | than 4C |
| 4C | UV-5411 | 190° F. | |
| 5 | UV-531 and | 190° F. | Greater than 50% testers |
| | UV-2908 | | report stronger fragrance |
| | | | than 5C |
| SC | UV-531 | 190° F. | |

*Temperature of Wax after stabilizers are added. Higher temperatures will result in more noticeable fragrance differences.
^{#} Total stabilizer concentration at 0.3% by weight.
UV-2908 at 0.1% by weight.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

What is claimed is:

1. A stabilized fragrance candle composition comprising
(a) wax;
(b) fragrance; and
(c) a stabilizing composition comprising
(i) a UV absorber; and
(ii) a hindered hydroxybenzoate.

2. The candle composition of claim 1, wherein said UV absorber is selected from the group consisting of 2-(2′-hydroxyphenyl)benzotriazoles, 2-hydroxybenzophenones and mixtures thereof.

3. The candle composition of claim 1, wherein said hindered hydroxybenzoate has the formula V: 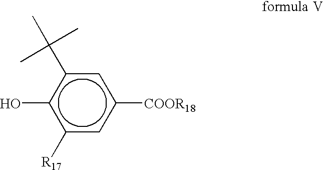
wherein R₁₇ is a C₁-C₈ alkyl and R₁₈ is a C₁-C₂₄ alkyl, or substituted or unsubstituted C₁-C₂₄ aryl.

4. The candle composition of claim 1, wherein said hindered hydroxybenzoate is selected from the group consisting of: 2,4-di-tert-butylphenyl-3,5-di-tert-butyl-4-hydroxybenzoate; hexadecyl-3,5-di-tert-butyl-4-hydroxybenzoate; octadecyl-3,5-di-tert-butyl-4-hydroxybenzoate; octyl-3,5-di-tert-butyl-4-hydroxybenzoate; tetradecyl-3,5-di-tert-butyl-4-hydroxybenzoate; behenylyl-3,5-di-tert-butyl-4-hydroxybenzoate; 2-methyl-4,6-di-tert-butylphenyl-3,5-di-tert-butyl-4-hydroxybenzoate and butyl 3-[3-t-butyl-4-(3,5-di-t-butyl-4-hydroxybenzoyloxy)phenyl]propionate and mixtures thereof.

5. The composition of claim 2, wherein said 2-(2′-hydroxyphenyl)benzotriazole is selected from the group consisting of: 2-(2′-hydroxy-5′-methylphenyl)-benzotriazole; 2-(3′,5′-di-tert-butyl-2′-(5′-tert-butyl-2′-hydroxyphenyl)benzotriazole; 2-(2′-hydroxy-5′-(1,1,3,3-tetramethylbutyl)phenyl)benzotriazole; 2-(3′,5′-di-tert-butyl-2′-hydroxyphenyl)-5-chlorobenzotriazole; 2-(3′-tert-butyl-2′-hydroxy-5′-methylphenyl)-5-chloro-benzotriazole; 2-(3′-sec-butyl-5′-tert-butyl-2′-hydroxyphenyl)-benzotriazole; 2-(2′-hydroxy-4′-octoxyphenyl)benzotriazole; 2-(3′,5′-di-tert-amyl-2′-hydroxphenyl)benzotriazole; 2-(3′,5′-bis(α,α-dimethylbenzyl)-2′-hydroxyphenyl)-benzotriazole; a mixture of 2-(3′-tert-butyl-2′-hydroxy-5′-(2-octyloxycarbonylethyl)phenyl)-5-chloro-benzotriazole; 2-(3′-tert-butyl-5′-[2-(2-ethylhexyloxy)-carbonylethyl]-2′-hydroxyphenyl)-5-chloro-benzotriazole; 2-(3′-tert-butyl-2′-hydroxy-5′-(2-methoxycarbonylethyl)phenyl)-5-chloro-benzotriazole; 2-(3′-tert-butyl-2′-hydroxy-5′-(2-methoxycarbonylethyl)phenyl)benzotriazole; 2-(3′-tert-butyl-2′-hydroxy-5′-(2-octyloxycarbonylethyl)phenyl)benzotriazole; 2-(3′-tert-butyl-5′-[2-(2-ethylhexyloxy)carbonylethyl]-2′-hydroxyphenyl)benzotriazole; 2-(3′-dodecyl-2′-hydroxy-5′-methylphenyl)benzotriazole; 2-(3′-tert-butyl-2′-hydroxy-5′-(2-isooctyloxycarbonylethyl)phenylbenzotriazole; 2,2-methylenebis[4-(1,1,3,3-tetramethylbutyl)-6-benzotriazol-2-ylphenol]; the transesterification product of 2-[3′-tert-butyl-5′-(2-methoxycarbonylethyl)-2′-hydroxyphenyl]benzotriazole with polyethylene glycol 300; and [R—CH₂CH—COO(CH₂)₃]₂ B where R=3′-tert-butyl-4′-hydroxy-5′-2H-benzotriazol-2-ylphenyl and mixtures thereof.

6. The composition of claim 2, wherein said 2-hydroxybenzophenone is selected from the group consisting of: 2-hydroxy-4-hydroxy-benzophenone; 2-hydroxy-4-methoxy-benzophenone; 2-hydroxy-4-octoxy-benzophenone; 2-hydroxy-4-decyloxy-benzophenone; 2-hydroxy-4-dodecylox-benzophenone; 2-hydroxy-4-benzyloxy-benzophenone; 2′,4,4′-trihydroxy-benzophenones; 2-hydroxy-4,4′-dimethoxy-benzophenone; 2,2′-dihydroxy-4-methoxybenzophenone; 2-hydroxy-4-n-octoxy-benzophenone and mixtures thereof.

7. The composition of claim 1, wherein the amount of said UV absorber in the candle composition is about 0.01 to about 1 wt %, and the amount of said hindered hydroxybenzoate in the candle composition is about 0.01 to about 1 wt %, based on the total weight of the candle composition.

8. The composition of claim 1, further comprising a pigment or an antioxidant.

9. A stabilized fragrance candle composition comprising
(a) wax;
(b) fragrance; and
(c) a stabilizing composition comprising
(i) a 2-(2′-hydroxyphenyl)benzotriazole;
(ii) a 2-hydroxybenzophenone; and
(iii) a hindered hydroxybenzoate.

10. The candle composition of claim 9, wherein said hindered hydroxybenzoate has the formula V: 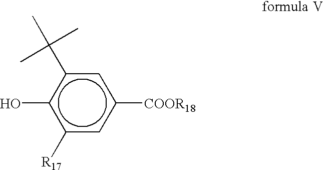
wherein R₁₇ is a C₁-C₈ alkyl and R₁₈ is a C₁-C₂₄ alkyl, or substituted or unsubstituted C₁-C₂₄ aryl.

11. The candle composition of claim 9, wherein said hindered hydroxybenzoate is selected from the group consisting of: 2,4-di-tert-butylphenyl-3,5-di-tert-butyl-4-hydroxybenzoate; hexadecyl-3,5-di-tert-butyl-4-hydroxybenzoate; octadecyl-3,5-di-tert-butyl-4-hydroxybenzoate; octyl-3,5-di-tert-butyl-4-hydroxybenzoate; tetradecyl-3,5-di-tert-butyl-4-hydroxybenzoate; behenylyl-3,5-di-tert-butyl-4-hydroxybenzoate; 2-methyl-4,6-di-tert-butylphenyl-3,5-di-tert-butyl-4-hydroxybenzoate and butyl 3-[3-t-butyl-4-(3,5di-t-butyl-4-hydroxybenzoyloxy)phenyl]propionate and mixtures thereof.

12. The candle composition of claim 9, wherein said 2-(2′-hydroxyphenyl)benzotriazole is selected from the group consisting of: 2-(2′-hydroxy-5′-methylphenyl)-benzotriazole; 2-(3′,5′-di-tert-butyl-2′-(5′-tert-butyl-2′-hydroxyphenyl)benzotriazole; 2-(2′-hydroxy-5′-(1,1,3,3-tetramethylbutyl)phenyl)benzotriazole; 2-(3′,5′-di-tert-butyl-2′-hydroxyphenyl)-5-chlorobenzotriazole; 2-(3′-tert-butyl-2′-hydroxy-5′-methylphenyl)-5-chloro-benzotriazole; 2-(3′-sec-butyl-5′-tert-butyl-2′-hydroxyphenyl)-benzotriazole; 2-(2′-hydroxy-4′-octoxyphenyl)benzotriazole; 2-(3′,5′-di-tert-amyl-2′-hydroxphenyl)benzotriazole; 2-(3′,5′-bis(α,α-dimethylbenzyl)-2′-hydroxyphenyl)-benzotriazole; a mixture of 2-(3′-tert-butyl-2′-hydroxy-5′-(2-octyloxycarbonylethyl)phenyl)-5-chloro-benzotriazole; 2-(3′-tert-butyl-5′-[2-(2-(2-ethylhexyloxy)-carbonylethyl]-2′hydroxyphenyl)-5-chloro-benzotriazole, 2-(3′-tert-butyl-2′-hydroxy-5′-(2-methoxycarbonylethyl)phenyl)-5-chloro-beznotriazole; 2-(3′-tert-butyl-2′-hydroxy-5′-(2-methoxycarbonylethyl)phenyl)benzotriazole; 2-(3′-tert-butyl-2′-hydroxy-5′-(2-octyloxycarbonylethyl)phenyl)benzotriazole; 2-(3′-tert-butyl-5′-[2-(2-ethylhexyloxy)carbonylethyl]-2′-hydroxyphenyl)benzotriazole; 2(3′-dodecyl-2′-hydroxy-5′-methylphenyl)benzotriazole; 2-(3′-tert-butyl-2′-hydroxy-5′-(2-isooctyloxycarbonylethyl)phenylbenzotriazole; 2,2-methylenebis[4-(1,1,3,3-tetramethylbutyl)-6-benzotriazol-2-ylphenol]; the transesterification product of 2-[3′-tert-butyl-5′-(2-methoxycarbonylethyl)-2′-hydroxyphenyl]benzotriazole with polyethylene glycol 300; and [R—CH₂CH—COO(CH₂)₃]₂ B where R=3′-hydroxy-5′-2H-benzotriazol-2-ylphenyl and mixtures thereof.

13. The candle composition of claim 9, wherein said 2-hydroxybenzophenone is selected from the group consisting of: 2-hydroxy-4-hydroxy-benzophenone; 2-hydroxy-4-methoxy-benzophenone; 2-hydroxy-4-octoxy-benzophenone; 2-hydroxy4-decyloxy-benzophenone; 2-hydroxy-4-dodecylox-benzophenone; 2-hydroxy-4-benzyloxy-benzophenone; 2′,4,4′-trihydroxy-benzophenones; 2-hydroxy4,4′-dimethoxy-benzophenone; 2,2′-dihydroxy-4-methoxybenzophenone; 2-hydroxy-4-n-octoxy-benzophenone and mixtures thereof.

14. The candle composition of claim 9, wherein the amount of said 2-hydroxybenzophenone in the candle composition is about 0.01 to about 1 wt %, the amount of said 2-(2′-hydroxyphenyl)benzotriazole in the candle composition is about 0.01 to about 1 wt % and the amount of said hindered hydroxybenzoate in the candle composition is about 0.01 to about 1 wt %, based on the total weight of the candle composition.

15. The candle composition of claim 9, further comprising a pigment or an antioxidant.
